(19) United States
(12) Patent Application Publication
(10) Pub. No.: US 2013/0319247 A1
(43) Pub. Date: Dec. 5, 2013

(54) EVAPORATED FUEL TREATMENT APPARATUS

(71) Applicant: Aisan Kogyo Kabushiki Kaisha, Obu-shi (JP)

(72) Inventor: Norihisa Yamamoto, Aichi (JP)

(73) Assignee: Aisan Kogyo Kabushiki Kaisha, Obu-shi (JP)

(21) Appl. No.: 13/904,118

(22) Filed: May 29, 2013

(30) Foreign Application Priority Data
May 30, 2012 (JP) 2012-123458

(51) Int. Cl. F02M 25/08

(52) U.S. Cl. CPC F02M 25/0854
USPC 96/143

(57) ABSTRACT

In an evaporated fuel treatment apparatus, for achieving common use of a casing, having a simple structure, the evaporated fuel treatment apparatus comprising: a casing having one or more adsorption chambers filled with an adsorbent that adsorbs and desorbs evaporated fuel generated in a fuel tank or the like; a tank port; a purge port; and an atmosphere port, and the casing is configured by directly connecting a first member that constitutes one end of the casing, and is provided with at least the tank port and the purge port, a second member that constitutes the other end thereof, and one or more cylindrical members provided between the first member and the second member.

### BACKGROUND OF THE INVENTION

(1) Field of the Invention

The present invention relates to an evaporated fuel treatment apparatus.

(2) Description of Related Art

In order to prevent evaporated fuel from being released to the atmosphere from a fuel tank of an automobile or the like, there has been used such a method that evaporated fuel generated in the fuel tank or the like is made to flow in an evaporated fuel treatment apparatus (hereinafter also referred to as a canister) provided with an adsorption chamber filled with activated carbon that adsorbs and desorbs the evaporated fuel, and that the evaporated fuel is temporarily made to be adsorbed to the activated carbon.

Since an amount of evaporated fuel generated from the fuel tank differs for each fuel tank capacity of a vehicle in which the canister is mounted, it is necessary to set a capacity or the like of the adsorption chamber according to the amount of evaporated fuel, and to design a casing of the canister corresponding to the capacity or the like of the adsorption chamber, and thus it has been difficult to achieve common use of the casing.

In addition, conventionally, there has been known a canister in which a side surface of a casing is formed in a bellows shape, and it can be expected to achieve common use of the casing by using the bellows-shaped casing (refer to JP-A-6-185423). However, a bellows-shaped canister has a problem that a structure thereof is complex, and that manufacturing cost is high.

### BRIEF SUMMARY OF THE INVENTION

Consequently, an object of the present invention is to provide an evaporated fuel treatment apparatus that has a simple configuration and can achieve common use of a casing.

For the object, the present invention is an evaporated fuel treatment apparatus provided with: a casing having one or more adsorption chambers filled with an adsorbent that adsorbs and desorbs evaporated fuel generated in a fuel tank or the like; a tank port; a purge port; and an atmosphere port, and the evaporated fuel treatment apparatus is characterized in that the casing is configured by directly connecting a first member that constitutes one end of the casing, and is provided with at least the tank port and the purge port, a second member that constitutes the other end thereof, and one or more cylindrical members provided between the first member and the second member.

In the present invention, a rib may be formed on an inner peripheral surface of the cylindrical member in a peripheral direction thereof.

In the present invention, there may be a structure that a flow path through which evaporated fuel flows is formed in the casing, and

a partition wall that constitutes the flow path is integrally formed in the cylindrical member.

In the present invention, there may be a structure that the flow path through which the evaporated fuel flows is formed in the casing,

an engagement portion is provided in the cylindrical member, and the partition wall that constitutes the flow path is provided to be engaged with the engagement portion.

In the present invention, the flow path may be formed in a U shape.

According to the present invention, the evaporated fuel treatment apparatus has the structure that the casing is configured by directly connecting the first member that constitutes the one end of the casing, and is provided with at least the tank port and the purge port, the second member that constitutes the other end thereof, and one or more cylindrical members provided between the first member and the second member, whereby a required adsorption amount (capacity) of an adsorbent can be dealt with by changing the number of cylindrical members. In addition, a common member with a simpler structure than in a conventional evaporated fuel treatment apparatus is used, and an evaporated fuel treatment apparatus of a desired body shape can be obtained. With this structure, common use of the casing can be achieved, and manufacturing cost can be reduced.

### BRIEF DESCRIPTION OF THE SEVERAL VIEWS OF THE DRAWING

FIG. 1 is an external view of an evaporated fuel treatment apparatus according to Embodiment 1 of the present invention;

FIG. 2 is a top view of the evaporated fuel treatment apparatus of FIG. 1;

FIG. 3 is a right side view of the evaporated fuel treatment apparatus of FIG. 1;

FIG. 4 is a perspective view of the evaporated fuel treatment apparatus of FIG. 1;

FIG. 5 is a cross-sectional view of a casing used for Embodiment 1 of the present invention, taken along a line V-V of FIG. 2;

FIG. 6 is a cross-sectional view of the casing used for Embodiment 1 of the present invention, taken along a line VI-VI of FIG. 2;

FIG. 7 is a cross-sectional view taken along the line V-V of FIG. 2;

FIG. 8 is an exploded perspective view of the casing used for Embodiment 1 of the present invention;

FIG. 9 is a perspective view of a second cylindrical member used for Embodiment 1 of the present invention;

FIG. 10 is a perspective view of another example of an evaporated fuel treatment apparatus according to Embodiment 1 of the present invention;

FIG. 11 is an exploded perspective view of a casing used for the example of FIG. 10;

FIG. 12 is a cross-sectional view of an evaporated fuel treatment apparatus according to Embodiment 2 of the present invention, corresponding to that in FIG. 5 of Embodiment 1;

FIG. 13 is an external view of an evaporated fuel treatment apparatus according to Embodiment 3 of the present invention;

FIG. 14 is a left side view of the evaporated fuel treatment apparatus of FIG. 13;

FIG. 15 is a cross-sectional view of a casing used for the evaporated fuel treatment apparatus of FIG. 13, corresponding to FIG. 5 of Embodiment 1;

FIG. 16 is a cross-sectional view of the evaporated fuel treatment apparatus of FIG. 13, corresponding to FIG. 7 of Embodiment 1;

FIG. 17 is an exploded perspective view of the casing used for the evaporated fuel treatment apparatus of FIG. 13;

FIG. 18 is a perspective view of a cylindrical member used for the evaporated fuel treatment apparatus of FIG. 13; and

FIG. 19 is an exploded perspective view of a casing used for a modified example of the evaporated fuel treatment apparatus shown in FIG. 13.

### DETAILED DESCRIPTION OF THE INVENTION

Modes for carrying out the present invention will be described based on drawings.

[Embodiment 1]

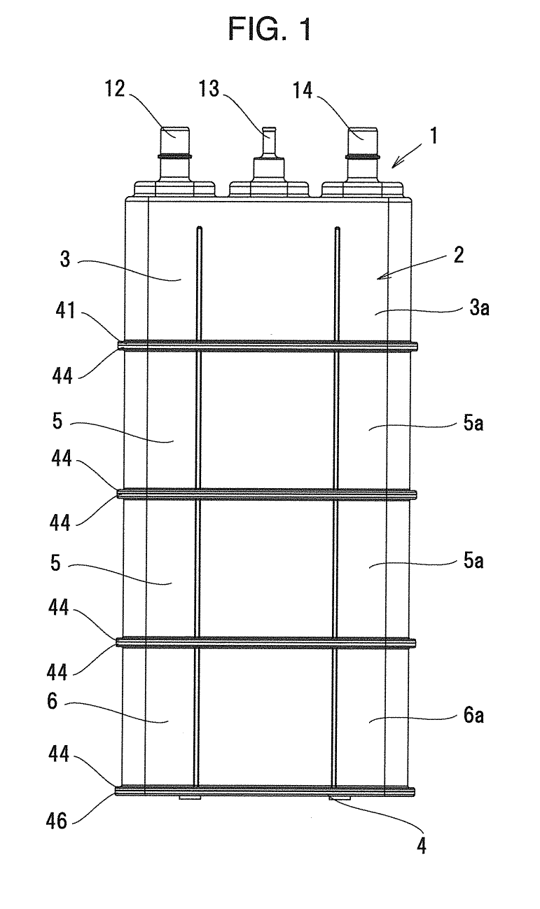

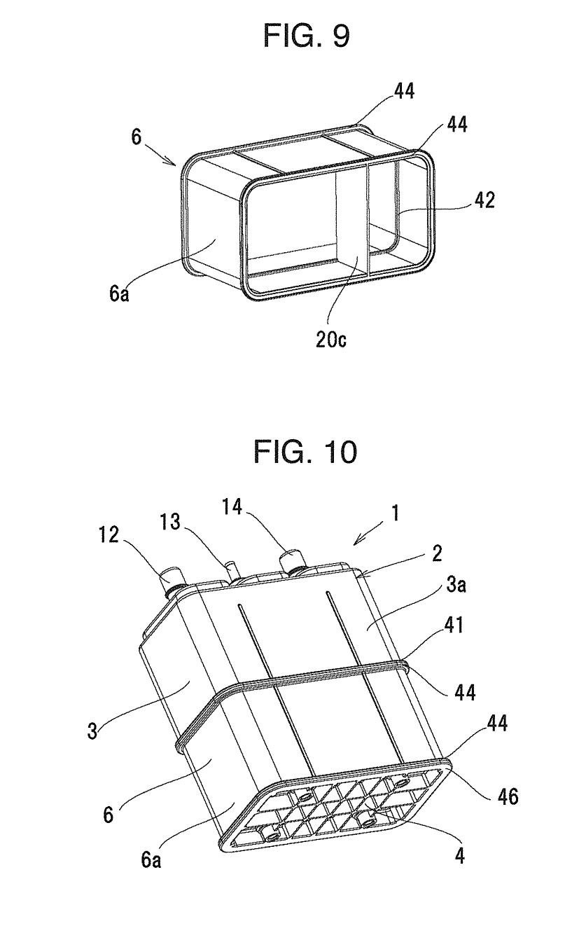

FIGS. 1 to 11 show Embodiment 1 according to the present invention.

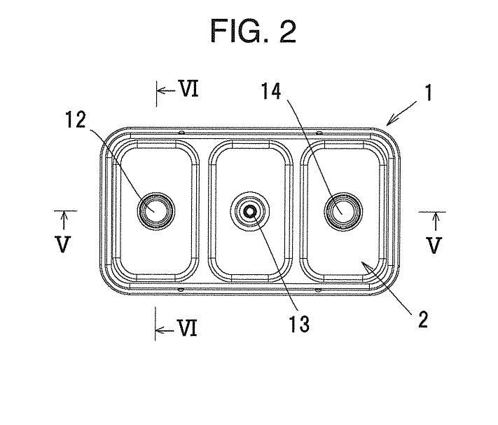

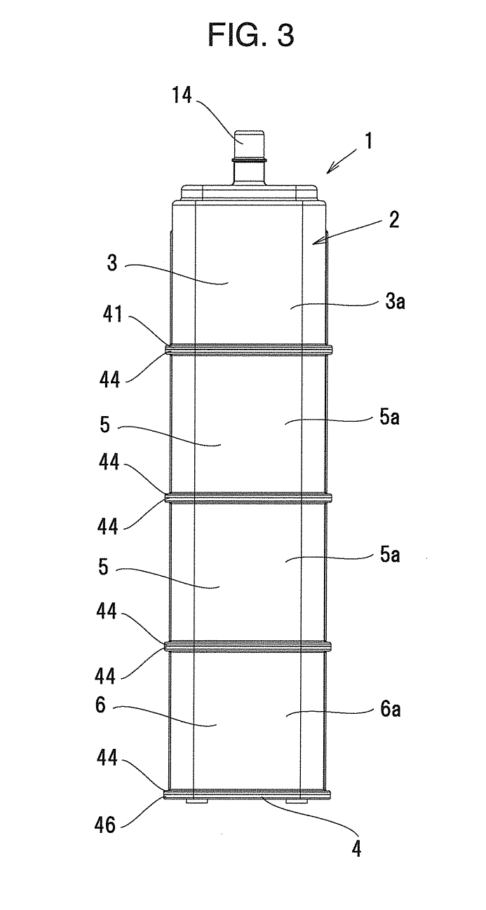

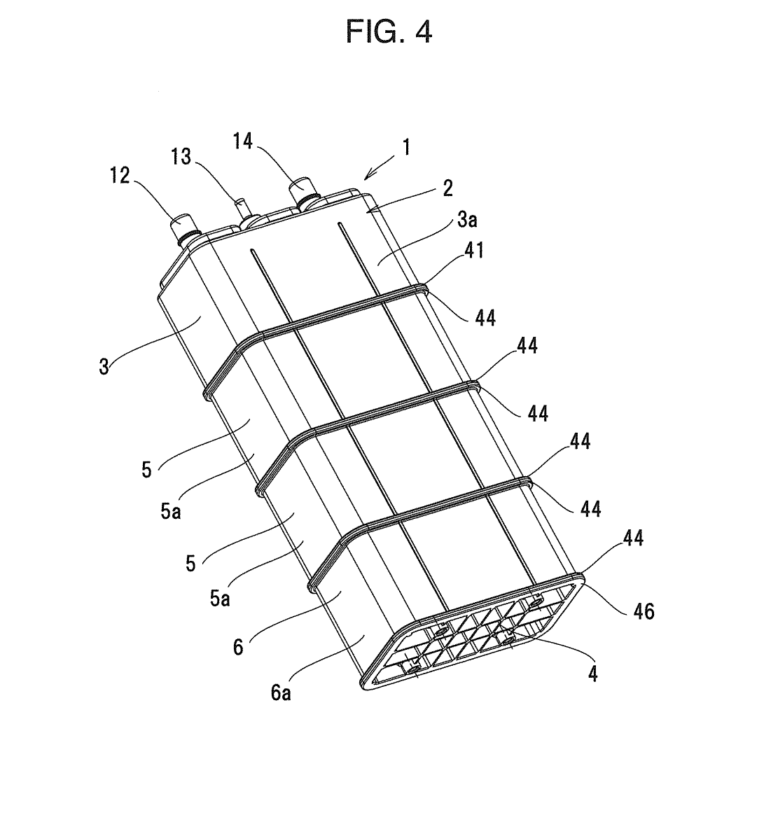

FIG. 1 shows an external view of an evaporated fuel treatment apparatus 1, FIG. 2 a top view of the evaporated fuel treatment apparatus 1 of FIG. 1, FIG. 3 is a right side view of the evaporated fuel treatment apparatus 1 of FIG. 1, and FIG. 4 a perspective view of the evaporated fuel treatment apparatus 1 of FIG. 1. The evaporated fuel treatment apparatus 1 may be longitudinally mounted in a vehicle, such as an automobile, so that top and bottom of FIG. 1 corresponds to a vertical direction, or may be used to be laterally mounted in the vehicle so that the top and bottom of FIG. 1 corresponds to a horizontal direction.

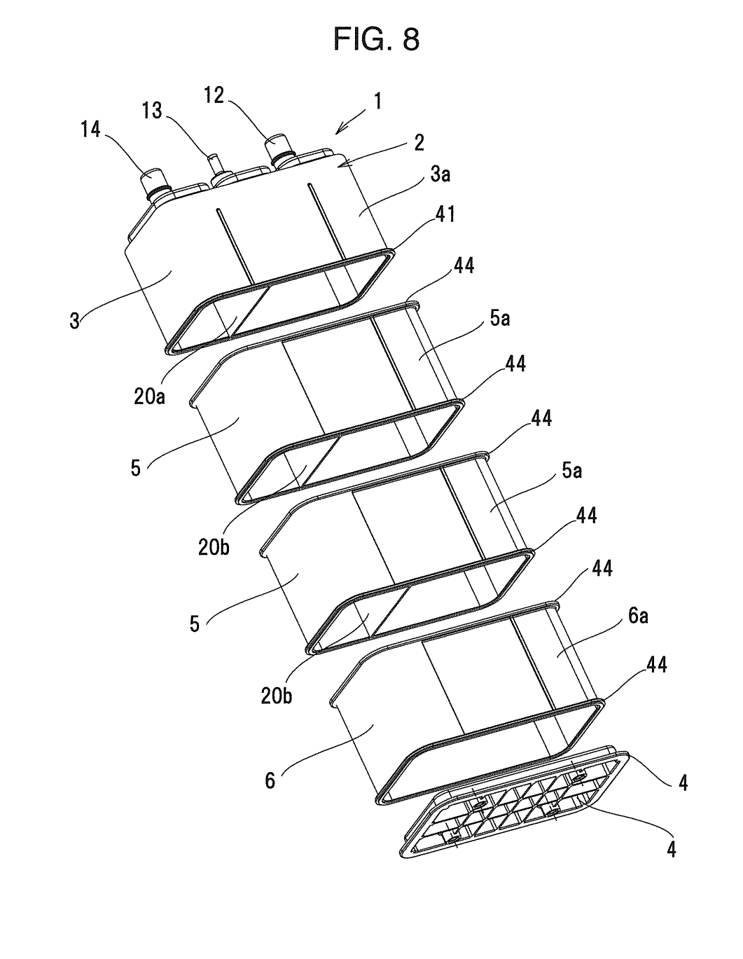

The evaporated fuel treatment apparatus 1, as shown in FIGS. 1 to 7, has a casing 2, and the casing 2 is, as shown in FIG. 8, configured by directly connecting in series a first member 3 that constitutes one end of the casing 2, a second member 4 that constitutes the other end thereof, and three cylindrical members 5, 5, 6 provided between the first member 3 and the second member 4.

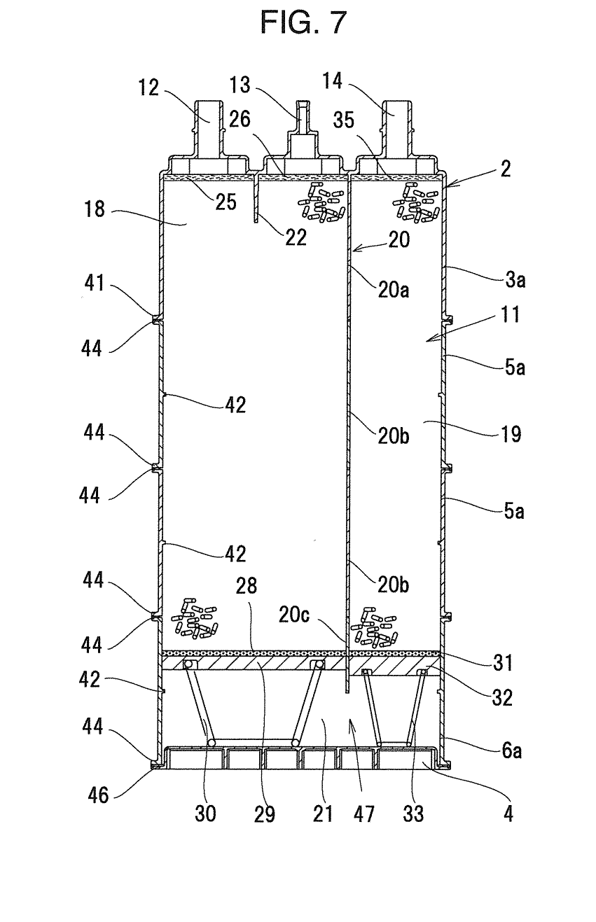

A flow path 11 through which a fluid can flow is formed inside the casing 2 as shown in FIG. 7, a tank port 12 and a purge port 13 are formed at an end on one end side of the flow path 11 in the casing 2, and an atmosphere port 14 is formed at an end on the other end side thereof.

The tank port 12, the purge port 13 and the atmosphere port 14 are provided on the first member 3. The tank port 12 is communicated with an upper air chamber of a fuel tank through a valve that is not shown, and the purge port 13 is connected to an intake passage of an internal combustion engine through a purge control valve (VSV) and a purge passage that are not shown. A divergence angle of the purge control valve is controlled by an ECU (electronic control unit), and purge control is performed during engine operation. The atmosphere port 14 is communicated with an outside through a passage that is not shown.

A plurality of adsorption chambers filled with an adsorbent that adsorbs and desorbs evaporated fuel generated in the fuel tank are, as shown in FIG. 7, provided in the flow path 11 in the casing 2 from a tank port 12 side to an atmosphere port 14 side as a first adsorption chamber 18 and a second adsorption chamber 19 in that order. In the embodiment, activated carbon with a predetermined average particle size is used as the adsorbent. It is to be noted that granulated activated carbon may be used as activated carbon.

A partition wall 20 is provided between the first adsorption chamber 18 and the second adsorption chamber 19 as shown in FIG. 7, and the partition wall 20 has partitioned the flow path 11 into the first adsorption chamber 18 and the second adsorption chamber 19. The partition wall 20 constitutes a part of a peripheral wall of the flow path 11.

The first adsorption chamber 18 and the second adsorption chamber 19 are communicated with each other through a space 21 formed in the casing 2 on an opposite side to the tank port 12 side, and the flow path 11 from the tank port 12 to the atmosphere port 14 is formed in a substantially U-shape that turns around in the space 21.

A baffle plate 22 reaching a part of the first adsorption chamber 18 is provided between the tank port 12 and the purge port 13 in the first member 3 of the casing 2. By the baffle plate 22, fluid flowing between the tank port 12 and the purge port 13 flows through the first adsorption chamber 18.

A filter 25 formed of nonwoven fabric, urethane, or the like is provided in a boundary portion between the tank port 12 and an end (one end) of the first adsorption chamber 18 on the tank port 12 side, and additionally, a filter 26 formed of nonwoven fabric, urethane, or the like is provided in a boundary portion between the purge port 13 and the end thereof.

In addition, on a surface of the first adsorption chamber 18 on a space 21 side is provided a filter 28 formed of urethane or the like that covers a whole area of the surface, and on the space 21 side of the filter 28 is provided a plate 29 having a number of communication holes. The plate 29 is biased to the tank port 12 side by biasing means 30, such as a spring.

On the space 21 side of the second adsorption chamber 19 is provided a filter 31 formed of urethane or the like that covers a whole area thereof. On the space 21 side of the filter 31 is provided a plate 32 in which a number of communication holes are provided substantially equally in a whole surface. The plate 32 is biased to the atmosphere port 14 side by biasing members 33, such as a spring.

On the atmosphere port 14 side of the second adsorption chamber 19 is provided a filter 35 formed of nonwoven fabric, urethane, or the like that covers a whole area thereof.

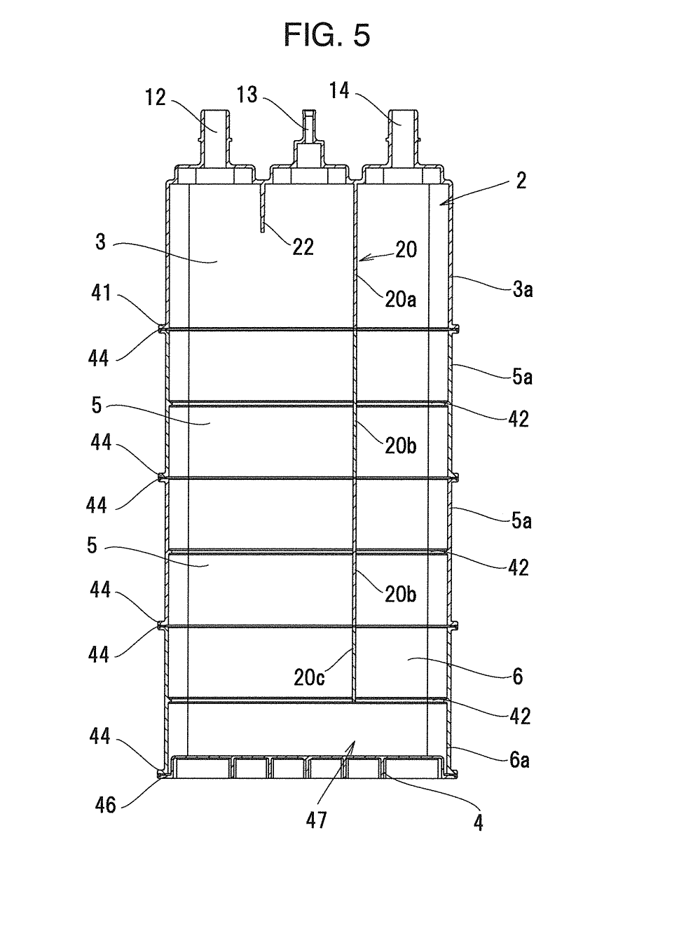

The first member 3, as shown in FIGS. 5, 6, 8, has a substantially rectangular cross section perpendicular to an axial direction (vertical direction of FIG. 5), it is formed in a square cylindrical shape having a peripheral wall 3a that is configured by an inner surface with a substantially same shape over the whole axial direction, the tank port 12, the purge port 13 and the atmosphere port 14 are formed on one end side in the axial direction of the first member 3, and the first member 3 on an other end side in the axial direction is opened. A first partition wall 20a that constitutes a part of the partition wall 20, and the baffle plate 22 are integrally formed in the first member 3. In addition, at an end of the peripheral wall 3a on an opening side is formed a flange 41 projecting to an outside direction thereof.

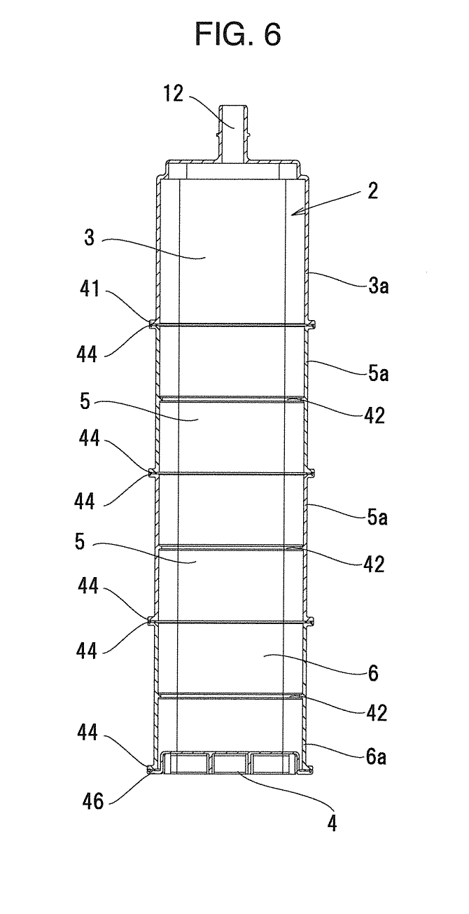

A cylindrical member provided between the first member 3 and the second member 4 is, as shown in FIGS. 5 and 6, configured by two types of first cylindrical member 5 and second cylindrical member 6 that have different lengths of partition walls 20b and 20c provided inside the cylindrical member.

Both of the cylindrical members 5 and 6, as shown in FIGS. 5, 6, 9, have substantially rectangular cross sections perpendicular to the axial direction (vertical direction of FIG. 5), they are formed in square cylindrical shapes having peripheral walls 5a and 6a that are configured by inner surfaces with a substantially same shape over the whole axial direction, and both ends in the axial direction of the cylindrical members 5 and 6 are opened. Cross sections perpendicular to the axial direction (vertical direction of FIG. 5) of the peripheral wall 5a of the first cylindrical member 5, the peripheral wall 6a of the second cylindrical member 6, and the peripheral wall 3a of the first member 3 are formed in a substantially same shape.

In addition, a rib 42 projecting inside is, as shown in FIGS. 5 and 6, formed at both the cylindrical members 5 and 6 over a whole peripheral direction of the inner surfaces in the peripheral walls 5a and 6a of the cylindrical members 5 and 6.

A flange 44 projecting to an outer direction is, as shown in FIGS. 5, 6, and 9, formed at both ends of the peripheral walls 5a and 6a of both cylindrical members 5 and 6.

Inside the first cylindrical member 5, the second partition wall 20b that constitutes a part of the partition wall 20 is located in the axial direction of the first cylindrical member 5, and is formed integrally with the peripheral wall over the whole axial direction thereof. In addition, in the first cylindrical member 5 and the first member 3 being connected to each other, or the cylindrical members 5 being connected to each other, the first partition wall 20a and the second partition wall 20b, or the second partition walls 20b are set to be located substantially collinearly.

Inside the second cylindrical member 6, the third partition wall 20c that constitutes a part of the partition wall 20 is located in the axial direction of the second cylindrical member 6, and is formed integrally with the peripheral wall between one opening end and the rib 42. In addition, in the first cylindrical member 5 and the second cylindrical member 6 being connected to each other, the second partition wall 20b and the third partition wall 20c are set to be located substantially collinearly.

These first partition wall 20a, second partition wall 20b, and third partition wall 20c are connected to one another to form the partition wall 20.

The second member 4 is, as shown in FIGS. 5, 6, and 9, a member that blocks an opening on an opposite side to the third partition wall 20c of the second cylindrical member 6. A flange 46 projecting to an outer direction is formed on a periphery of the second member 4. A space 47 is formed between an inner surface of the second member 4 and the third partition wall 20c as shown in FIGS. 5 and 6, and the flow path 11 is formed in a substantially U-shape that turns around in the space 47.

By arbitrary coupling means, such as overlapping the flanges 41, 44, and 46 of the adjacent members of the first member 3, the second member 4, and the cylindrical members 5 and 6 to bond the overlapped connection with welding, adhesive, or the like, or sandwiching rubber seal among the flanges to clip them together, adjacent members of the first member 3, the second member 4, and the cylindrical members 5 and 6 are directly connected to each other, and thereby the casing 2 is formed.

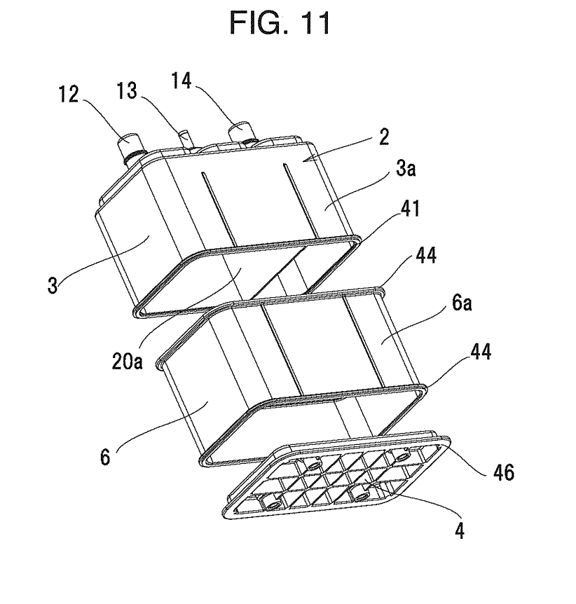

Although three cylindrical members are provided between the first member 3 and the second member 4 in the evaporated fuel treatment apparatus 1 shown in FIGS. 1 to 9, the number of the cylindrical members can be set as the arbitrary number, such as one or a plurality. In FIGS. 10 and 11, shown is an example where one second cylindrical member 6 is provided between the first member 3 and the second member 4.

As described above, the number of the first cylindrical members 5 provided between the first member 3 and the second member 4 is changed, and thereby, a capacity of the casing 2 can be easily changed. As a result of this, a required adsorption amount (capacity) of adsorbent can be dealt with by changing the number of the first cylindrical members 5, the evaporated fuel treatment apparatus 1 with a desired body shape can be obtained only by the common components 3, 4, 5, and 6, common use of the casing can be achieved, and manufacturing cost can be reduced.

Since both ends of the cylindrical members 5 and 6 are opened, and the cylindrical members 5 and 6 are formed in substantially the same shape over the whole axial direction, a molding die is easy to take in and out of both openings, and the rib 42 can be easily formed at inner peripheral surfaces thereof. In addition, by providing the rib 42 in the peripheral direction, even when the large casing 2 is used, the rib 42 functions as a reinforcing material, and strength can be sufficiently secured.

[Embodiment 2]

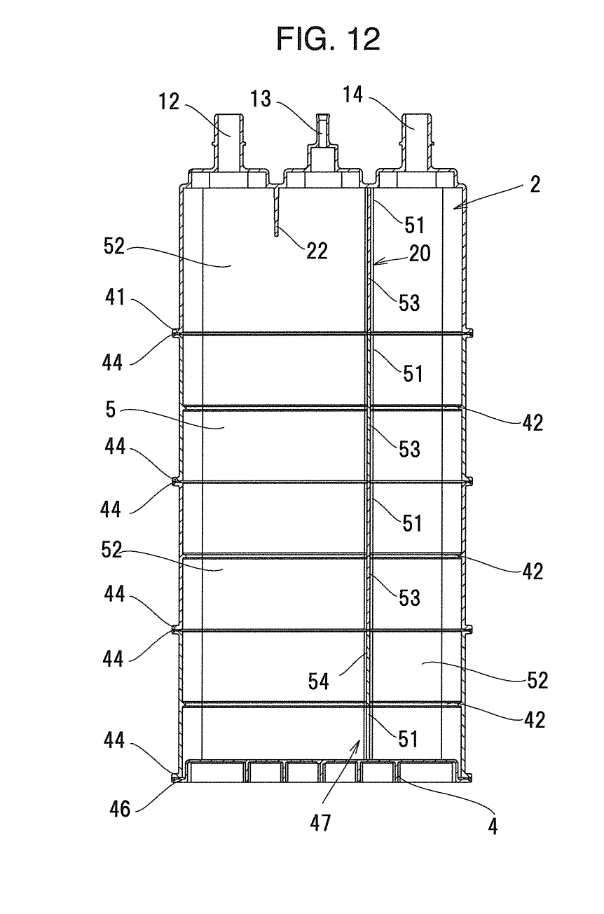

Although the partition walls 20a, 20b, and 20c and the peripheral wall in the first member 3 and the cylindrical members 5 and 6 are integrally formed in Embodiment 1, for example, a groove 51 as an engagement portion is formed in a peripheral wall as shown in FIG. 12, partition walls 53 and 54 as different bodies from the peripheral wall are engaged with the groove 51, and thereby the partition walls 53 and 54 may be attached to the peripheral wall. It is to be noted that the engagement portion can have an arbitrary shape as long as being a portion with which and to which the partition walls 53 and 54 can be engaged and attached in addition to the groove 51.

As a result of this, the partition walls 53 and 54 with different lengths are used, and thereby common use of one type of cylindrical member 52 can be achieved instead of using the first cylindrical member 5 and the second cylindrical member 6.

Since the other structures are similar to those of Embodiment 1, similar symbols are given to members similar to Embodiment 1, and description thereof will be omitted.

Embodiment 2 can also achieve an effect similar to Embodiment 1.

[Embodiment 3]

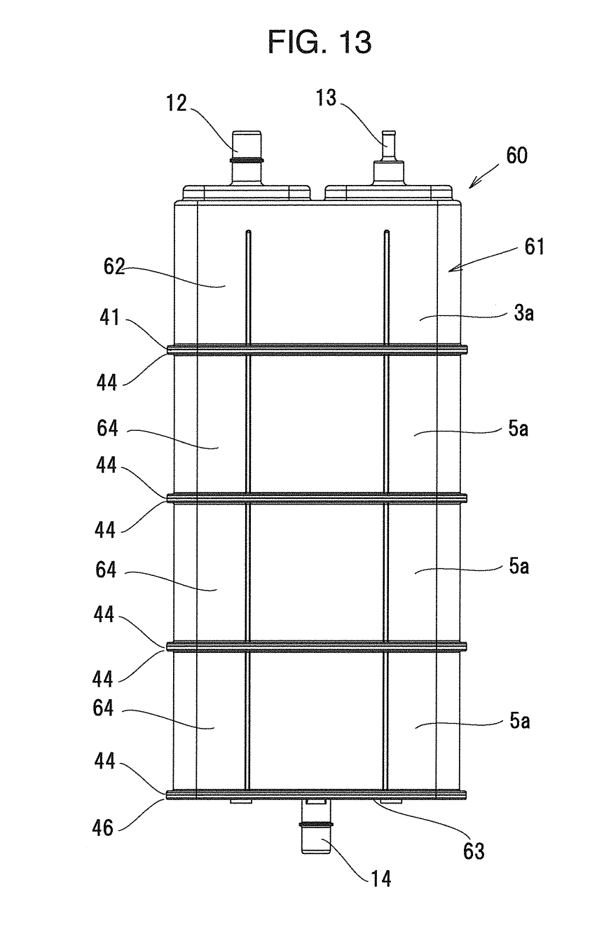

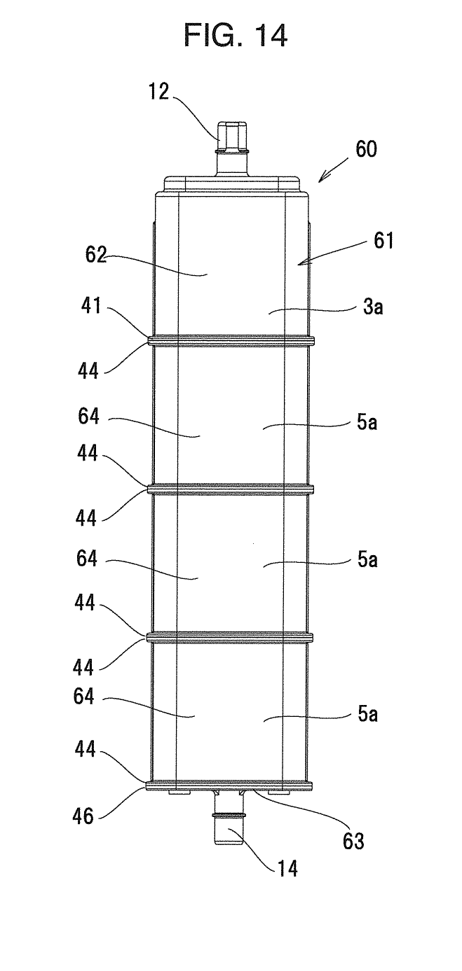

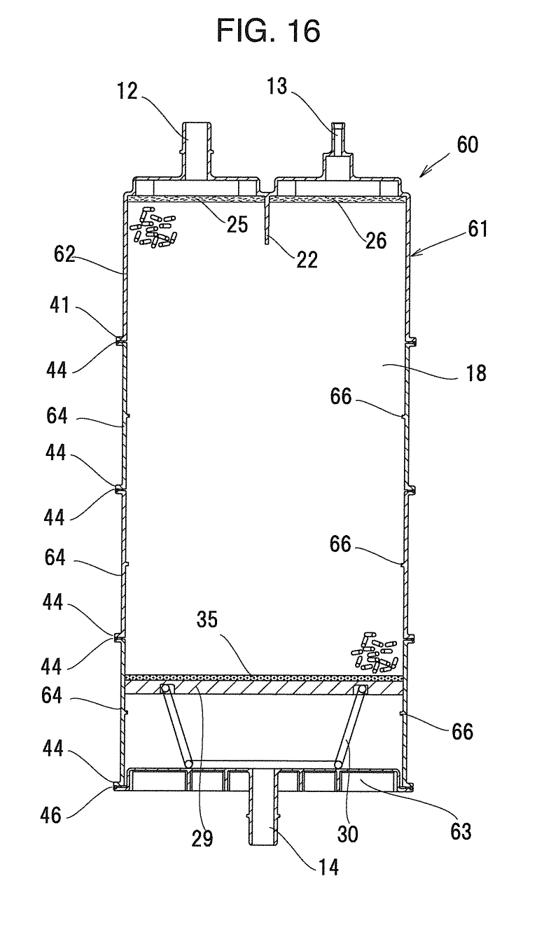

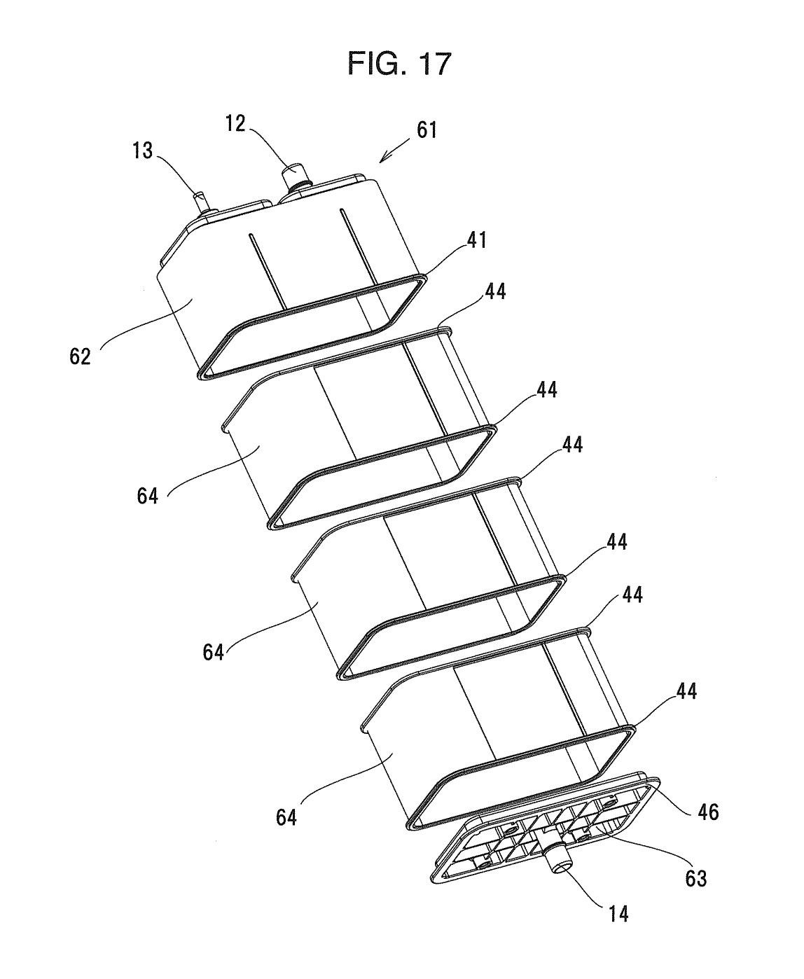

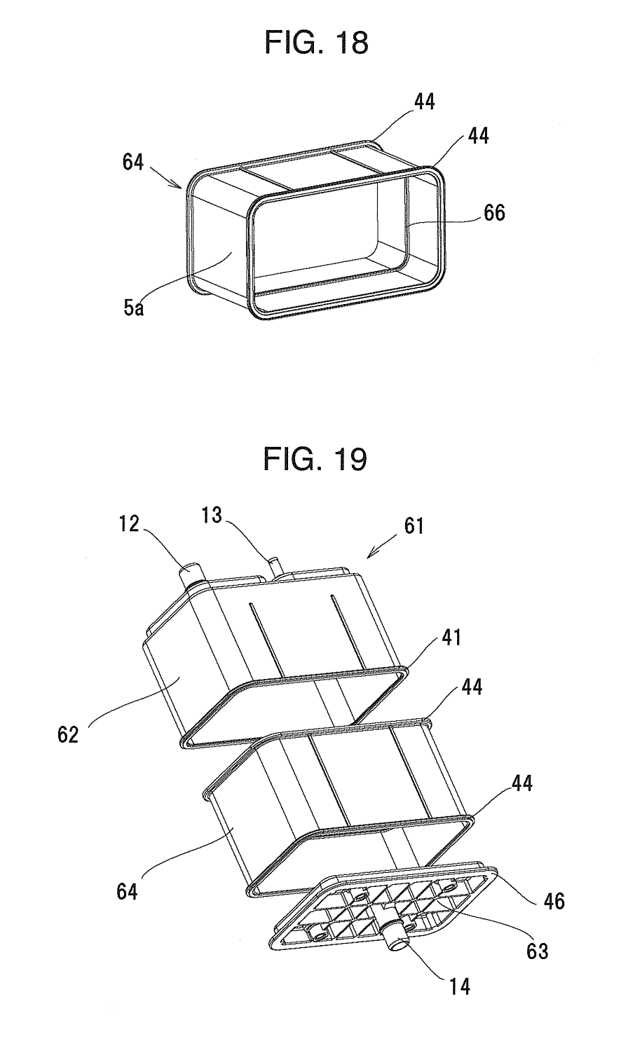

FIGS. 13 to 19 show Embodiment 3 according to the invention.

Although the U-shaped flow path 11 is formed in the casing 2 in Embodiment 1, the flow path 11 can be configured in an arbitrary shape, such as an I-shape without a turnaround, an N-shape with two turnarounds, and an M-shape with three turnarounds.

FIGS. 13 to 18 show an example where the present invention has been applied to an evaporated fuel treatment apparatus 60 in which the flow path 11 is formed in an I-shape.

A casing 61 of the evaporated fuel treatment apparatus 60 is configured by directly connecting in series a first member 62 provided with the tank port 12 and the purge port 13, a second member 63 provided with the atmosphere port 14, and three cylindrical members 64 provided between the first member 62 and the second member 63.

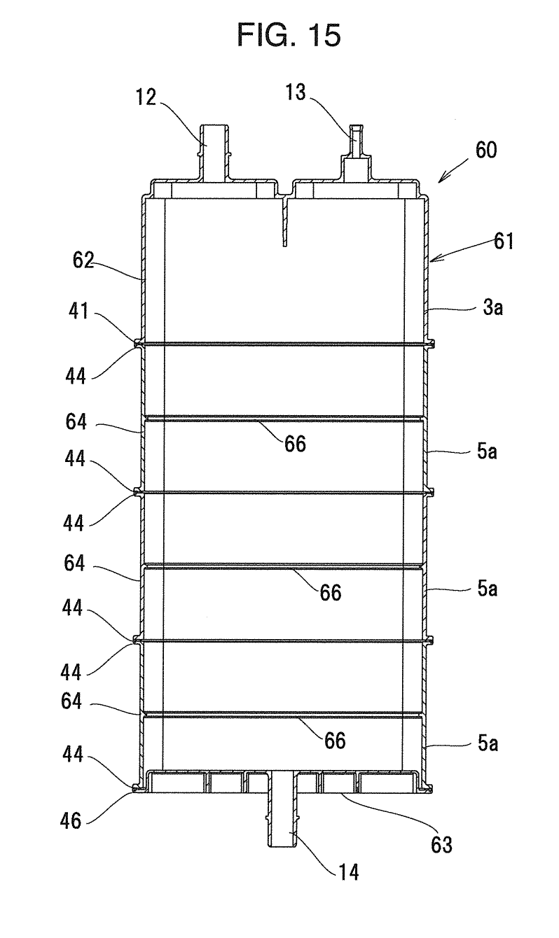

Although the partition wall 20 of Embodiments 1 and 2 is not formed inside the cylindrical member 64 as shown in FIGS. 15, 16, and 18, a rib 66 similar to the rib 42 in Embodiments 1 and 2 is formed.

Adsorption chambers, filters, and the like similar to Embodiments 1 and 2 are provided inside the casing 61, similar symbols are given to members that exhibit actions similar to the embodiments 1 and 2, and description thereof will be omitted.

Also in the evaporated fuel treatment apparatus 60 in this Embodiment 3, the number of the cylindrical members 64 is, as shown in FIG. 19, changed to the arbitrary number, such as one or a plurality, and thereby a capacity of the casing 61 can be easily changed similarly to Embodiments 1 and 2.

As described above, Embodiment 3 can achieve an effect similar to Embodiments 1 and 2.

[Other Embodiment]

In Embodiments 1 to 3, the peripheral walls of the casings 2 and 61 have the rectangular cross sections perpendicular to the axial direction excluding the rib 42, and they are formed in a substantially same shape over the whole axial direction, but as long as inner surfaces of the peripheral walls of the casings 2 and 61 are formed in a substantially same shape over the axial direction excluding the rib 42, the cross sections thereof can be formed in arbitrary shapes, such as a polygonal shape, a circular shape, and an elliptical shape.

In addition, the casings 2 and 61 of the present invention can be applied to an arbitrary evaporated fuel treatment apparatus, the number and arrangement of the adsorption chambers provided in the casings 2 and 61, other various structures, and the like are not limited to the ones shown in above Embodiments, and shown in the drawings, and a structure similar to an arbitrary evaporated fuel treatment apparatus can be employed.

1. An evaporated fuel treatment apparatus comprising: a casing having at least one adsorption chamber filled with an adsorbent that adsorbs and desorbs evaporated fuel generated in a fuel tank or the like; a tank port; a purge port; and an atmosphere port, wherein
said casing is configured by directly connecting a first member that constitutes one end of said casing and includes at least the tank port and the purge port, a second member that constitutes the other end thereof, and at least one cylindrical member provided between the first member and the second member.

2. The evaporated fuel treatment apparatus according to claim 1, wherein a rib is formed on an inner peripheral surface of the cylindrical member in a peripheral direction thereof.

3. The evaporated fuel treatment apparatus according to claim 1, wherein
a flow path through which the evaporated fuel flows is formed in said casing, and
a partition wall that constitutes said flow path is integrally formed in said cylindrical member.

4. The evaporated fuel treatment apparatus according to claim 1, wherein
a flow path through which the evaporated fuel flows is formed in said casing, and
an engagement portion is provided in said cylindrical member, and a partition wall that constitutes said flow path is provided to be engaged with said engagement portion.

5. The evaporated fuel treatment apparatus according to claim 3, wherein said flow path is formed in a U-shape.

6. The evaporated fuel treatment apparatus according to claim 4, wherein said flow path is formed in a U-shape.
